(19) United States
(12) Patent Application Publication
(10) Pub. No.: US 2004/0103056 A1
(43) Pub. Date: May 27, 2004

(54) Method, system and storage medium for asset securitization, and computer program product

(76) Inventors: Yuichi Ikeda, Mito (JP); Yasuhiro Kobayashi, Hitachinaka (JP); Masayuki Tani, Hitachinaka (JP); Keisuke Ogawa, Tokyo (JP); Hideo Nakazawa, Yokohama (JP); Hiroshi Hanyu, Yokohama (JP); Naoko Kodama, Funabashi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 09/800,494

(22) Filed: Mar. 8, 2001

(30) Foreign Application Priority Data
Nov. 2, 2000 (JP) 2000-335782

(51) Int. Cl. G06F 17/60

(52) U.S. Cl. 705/38; 705/35

(57) ABSTRACT

By using a client managing system, optimization of charge to be collected from a client and assortment of the client are carried out on the basis of information obtained by analyzing information on the payment of consideration paid by the client, and the information thus obtained is disclosed to investors, thereby providing a technique of advantageously securitizing assets to raise funds needed for the plant and equipment investment on enterprise equipment or communication equipment.

This application is based on Japanese Patent Application No. 2000-335782 filed in Japan, the contents of which are incorporated hereinto by reference.

### BACKGROUND OF THE INVENTION

1. Field of the Invention

The present invention relates to a technique of securitizing assets (converting assets into securities), and particularly to a technique of minimizing the probability for occurrence of a problem in payment of the capital/interest of securities as securitizing assets from which usage consideration can be obtained.

2. Description of the Related Art

When an enterprise company starts a new enterprise or expands its enterprise, the company needs capital investment, and thus raising of funds is necessary therefor. As a method of raising funds, it is conventional that the company borrows money from a bank, or that an equipment sales agent bears the cost for equipment and the company pays off the cost for the equipment to the equipment sales agent after the company's enterprise gets on track and the sales of the company increases. However, the loan of money from the bank induces a problem that the interest on the loan imposed on the company is increased. Further, the bearing of the expenses by the equipment sales agent imposes a great burden on the equipment sales agent. Therefore, there may occur such a situation that there is no agent undertaking the production and sales of equipment. This induces a problem that capital investment cannot be smoothly achieved. Therefore, a method of easily raising funds is needed.

Asset securitization is one method of raising funds. Recently, raising of funds has been generally carried out by securitizing immovables or the like. For example, securitization of housing loans, securitization of car loans, securitization of immovables, etc. (hereinafter merely referred to as “securitization”) are typical as a method of securitizing the assets. The summary of the standard articles to be securitiezed and the present situation of securitization in Japan are described in detail in “METHOD OF SECURITIZING FINANCIAL PROPERTIES” (edited by The Long-Term Credit Bank of Japan, Ltd., issued by Nihon Keizai Shinbunsha in 1993) or “INTRODUCTION ON ARTICLES TO BE SECURITIZED” (edited by The Nippon Credit Bank, Ltd., issued by Sigma Bayes Capital in 1999). In the securitization as described above, payment from a debtor, a lessee or the like is subjected to credit enhancement and then it is allotted to the payment of the principal/interest.

However, the conventional asset securitization methods as described above does not have a mechanism for controlling cash-in-flow of the payment. That is, there is not provided any mechanism for effectively utilizing assets to be securitized and ensuring the cash-in-flow. Therefore, there is a probability that an investor purchasing a security cannot receive payment of the capital/interest of the security as scheduled.

For example, in the case of a communication enterprise, in order to cope with developments of the communication technologies, increase of communication demand and utilization of new services, it is required to newly build communication equipment or renew equipment which have been so far used. That is, the plant and equipment investment is needed. Thus, a communication enterprise company is required to raise huge funds therefor, and then it is desired to raise funds at as low an interest rate as possible. For such purpose, it is needed to establish a mechanism to ensure redemption to investors.

### SUMMARY OF THE INVENTION

An object of the present invention is to provide a technique of favorably securitizing assets in order to raise funds necessary for plant and equipment investment.

In order to attain the above object, according to the present invention, there is provided a method of securitizing assets (hereinafter referred to as “asset securitization”) in order to raise the funds required to introduce equipment for an enterprise, which is an asset to gain profits for consideration paid by a client. At this time, the asset securitization is carried out while it is conditional to provide assistance for securing profits from the thus introduces equipment for the. This assistance is carried out during a refund period by a computer system connected to a system which operates the equipment for the enterprise. From the system operating the equipment, the computer system obtains and stores information on the payment of consideration from each client which is incurred along with use of the equipment for the enterprise. Further, the computer system investigates the payment status of the client on the basis of the information on the payment of consideration thus stored, and then carries out a charge optimization processing on the basis of the payment status to suppress reduction of an amount of money paid by each client, subsequently outputting the information representing a charge scheme estimated through the charge optimization processing.

According to the present invention, the asset securitization to raise funds for capital investment can be favorably carried out.

### BRIEF DESCRIPTION OF THE DRAWING

These and other features, objects and advantages of the present invention will be come more apparent from the following description when taken in conjunction with the accompanying drawings wherein:

FIG. 1 is a block diagram showing an outline on a mechanism for asset securitization of communication equipment to which the present invention is applied;

FIG. 2 is a diagram showing advantages of the asset securitization according to the present invention;

FIG. 3 is a block diagram showing an asset securitizing mechanism carried out on the basis of an equipment trust system according to an embodiment of the present invention;

FIG. 4 is a block diagram showing the construction of a communication company and the system configuration of a client management system;

FIG. 5 is a diagram showing the structure of client data stored in a storage device of the client managing system;

FIG. 6 is a diagram showing the time-sequential mutual relationship in the asset securitization based on the equipment trust system according to the embodiment of the present invention;

FIG. 7 is a flowchart showing the processing flow in the communication company when securitizing asset based on the equipment trust system according to the embodiment of the present invention;

FIG. 8 is a flowchart showing the processing flow in the manufacturing company when securitizing asset based on the equipment trust system according to the embodiment of the present invention;

FIG. 9 is a block diagram showing the mechanism for the asset securitization carried out on the basis of a selling-out method according to another embodiment of the present invention;

FIG. 10 is a diagram showing the time-sequential mutual relationship in the asset securitization based on the selling-out method according to the other embodiment of the present invention;

FIG. 11 is a flowchart showing the processing flow in the communication company when securitizing asset based on the selling-out method according to the other embodiment of the present invention;

FIG. 12 is a flowchart showing the processing flow in the manufacturing company when the asset securitization based on the selling-out method according to the other embodiment of the present invention is carried out;

FIG. 13 is a diagram showing the composition of a security for which the capital/dividend payment is made, which is one example of the security issued in the present invention;

FIG. 14 is a flowchart showing the processing flow of the client management system used in the present invention;

FIG. 15 is a graph showing the effect achieved by carrying out the client managing processing for securing the profits according to the present invention;

FIG. 16 is a diagram showing the construction of a client portfolio;

FIG. 17 is a graph showing an example of an effective frontier; and

FIG. 18 is a diagram illustrating a display example of a web site showing a status of securing a profit from assets which is for securitization product whose information is to be disclosed to clients.

### DETAILED DESCRIPTION OF THE INVENTION

According to the present invention, there is provided a method of securitizing asset for raising funds required to introduce a facility for communication or other business which is an asset to gain profits from consideration paid by a client. When the asset securitization is carried out, it is conditional to provide assistance for securing profits from the equipment thus introduced. This assistance is carried out during a security refund period by a computer system connected to a system which operates the equipment. Further, there is provided an asset securitizing system using the asset securitizing method.

The computer system of the present invention obtains, from the system operating the equipment, information on payment of consideration from each client which incurs due to client's use of the equipment, and then stores the thus obtained information. Further, the computer system investigates the payment status of each client on the basis of the information on the payment of consideration thus stored, and carries out charge optimizing processing to suppress reduction of an amount of clients' payment on the basis of the payment status, subsequently outputting information representing a charge system. Further, according to the present invention, there are provided a computer-readable storage medium which holds programs to implement the processing in the computer system, and a computer program product.

Further, according to the present invention, there is provided a profit securing assist system for assisting the securing of profits from assets, when the assets concerned are securitized (i.e., the assets are converted to securities) to raise the funds required to introduce an enterprise facility or communication facility with which the profits are obtained from consideration paid by each client, wherein the profit securing assist system has the above computer system as a computer system for assisting the securing of the profits from the facility thus introduced.

Still further, according to the present invention, there is provided a method of assisting introduction of the facility for enterprise or communication with which profits are gained from consideration paid by each client, comprising the steps of: in order to raise funds needed to introduce the enterprise equipment or communication equipment, issuing securities refund of which is carried out based on consideration from clients; constructing a computer system for assisting to secure profits from the equipment introduced when the securities are issued; and continuously carrying out during at least a security refund period (1) the processing of obtaining, from a system operating the facility, information on payment of consideration from each client which incurs due to client's use of the equipment; (2) the processing of investigating the payment status of each client on the basis of the information on the payment of the consideration stored; and (3) the processing of optimizing the charge to suppress reduction of an amount of money paid by each client on the basis of the payment status and (4) outputting information representing a charge system.

### The Preferred Embodiments

Preferred embodiments according to the present invention will be described.

The present invention is preferably applied to the securitization of assets which are provided for client's use to make a charge for the client's use of the assets. Therefore, the following embodiments will be described by applying the present invention to a case where the payment of the purchase cost for communication equipment constituting a communication infrastructure used for communication is carried out through the asset securitization. It is needless to say that the assets to be securitized are not limited to the communication equipment in the communication business. For example, the present invention may be also applied to electric power equipment in the power supply business and equipment, vehicles, air planes, ships and the like in passenger transit/freight transportation business.

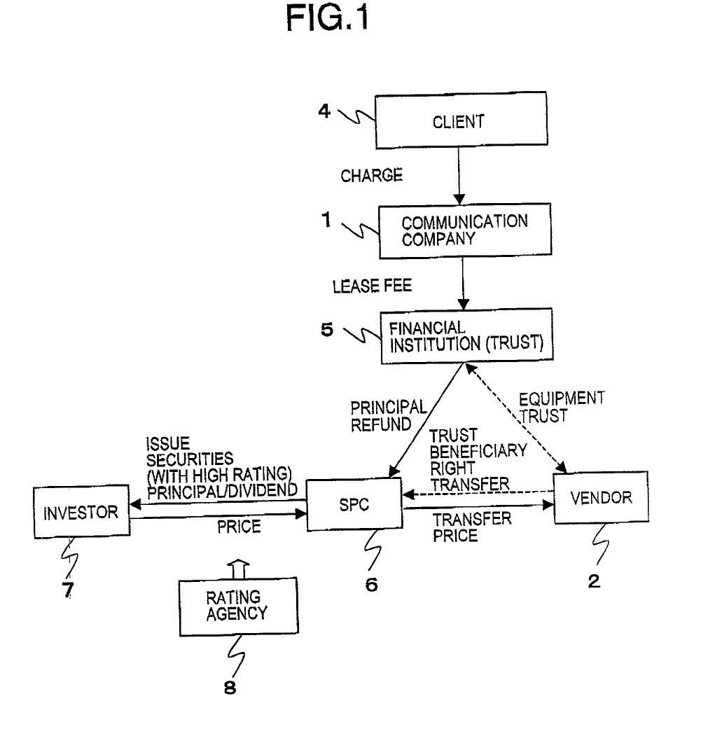

FIG. 1 schematically shows an asset securitizing mechanism for communication equipment. In this embodiment, when an enterprise company which supplies communication services (hereinafter referred to as “communication ccmpany”) makes a plant and equipment investment for communication equipment, the payment of the manufacturing expense of the communication equipment to a manufacturing company which has manufactured the communication equipment is carried out by securitizing a trust beneficiary right of the equipment.

In the case of FIG. 1, a communication company 1 which needs capital investment on equipment for communication, a manufacturing company (represented as “vendor” in FIG. 1) 2 which supplies the equipment for communication, a financial institution 5 and a special purpose company (SPC) 6 which execute asset securitization and investors 7 are involved in the movement of funds through the asset securitization. According to this embodiment adopted is a mechanism based on such an equipment trust system wherein the communication company 1 uses, on lease, the equipment for communication manufactured by the manufacturing company 2 and then trust-transferred to a trust company such as a financial institution 5 or the like. In the following description, this mechanism will be merely referred to as “equipment trust system” in order to simplify the description.

Further, in this embodiment, the trust financial institution 5 issues a trust beneficiary right certificate for the trust-transferred equipment for communication and grants the certificate to the vendor 2. The vendor 2 transfers the trust beneficiary right certificate to SPC 6 to gain a transfer price, thereby collecting the cost of the equipment for communication. SPC 6 issues securities on, the basis of the trust beneficiary right certificate, and sells them to investors to collect the transfer price. The communication company 1 takes the loan of the communication equipment from the trust financial institution and supplies the communication equipment for client's use, thereby earning the income based on the usage charge from the clients. The communication company 1 pays a lease fee to the financial institution 5 from the income based on the use charge. The financial institution 5 refunds the principal to SPC 6 on the basis of the lease fee thus paid. SPC 6 pays the principal/dividend to the investors 7 on the basis of the principal refunded.

When the securities are issued, the securities may be subjected to ranking by a ranking agency 8. Here, if the ranking agency gives a high ranking to the securities, it is indicated that the securities concerned have a high level of safety, and thus purchase and sales of the securities becomes easy in the financial market. In the present invention, a system for assisting to secure profits may be used as described later. Accordingly, such system enables risk reduction in refund (redemption), and thus it is expected that a ranking agency gives a high ranking to the securities concerned.

As the securities issued in the “equipment trust system” as described above are known a pay-through certificate which is issued on the basis of the trust beneficiary right to the equipment trust and have a senior/subordinate debt structure by the specific purpose company (SPC), and, a pass-through certificate based on simple equipment trust. In the present invention, any type of securities may be implemented. Since the pass-through certificate symbolizes the ownership to a trust property, it is possible for the vendor 2 to directly issue the securities through no SPC 6 to raise funds, and the trust financial institution 5 carries out the payment of the capital and the interest. Accordingly, in the following description, when the pass-through certificates are issued, the investors 7 and the manufacturing company 2 are assumed to directly communicate with each other without SPC 6. However, it is needless to say that the pass-through certificates can be issued through SPC 6.

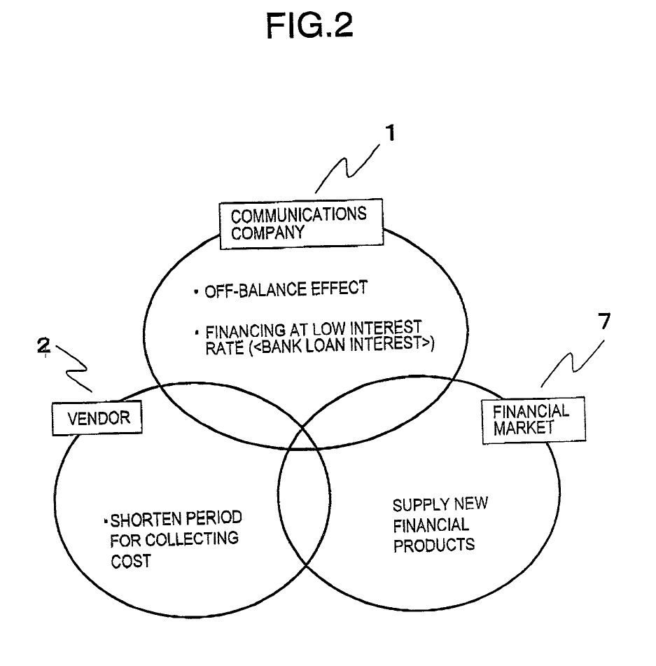

FIG. 2 schematically shows the advantages of the raising of funds based on the asset securitization.

In this embodiment, through a security refund period, the communication company 1 takes the loan of the equipment for communication entrusted to the financial institution 5 on the basis of the equipment trust system, uses the communication equipment and pays the lease fee to the financial institution 5. At the time when the refund period is terminated, the communication company 1 purchases the equipment for communication at the residual value at that time. Accordingly, as shown in FIG. 2, the communication company 1 can raise the funds at a lower interest rate than a loan interest rate of a bank. Further, since the communication company 1 do not own the asset itself, it can obtain an off-balance effect on the accounts. Besides, the vendor 2 can collect the transfer price of the communication equipment in a short period, and improve cash-flow. Further, the principal and the interest are paid to the financial market, that is, the investors 7 on the basis of the usage charge of the equipment for communication. Therefore, there can be provided a new type of financial product which have a relatively low level of risk and to which it would be expectable to have high dividends with frequent use of the equipment.

The financing method as described above is a method based on the asset securitizing method using management disposal type equipment trust. This method may be changed in accordance with the legislation. However, it can be expected to have the following advantages: (1) the manufacturing company 2 can receive a lump-sum payment of cost for the equipment for communication at the time when it supplies the equipment; (2) the communication company 1 can pay the expense of the equipment for communication on the long-term installment plan; (3) no consumption tax is imposed because of the trust system; and (4) the communication company 1 can reckon up the loaned communication equipment as an asset of the communication company 1 in terms of the financial affairs/accounts, and thus it can depreciate the communication equipment. On the otter hand, there are the following disadvantages (1) there is a risk that the communication company 1 revokes the lease contract during the refund, period for the reason why the equipment is old-fashioned or the like; and (2) the communication company 1 has no ownership of the equipment for communication until the trust is finished (the trust bank owns the equipment for communication).

As a similar method, there may be used a management type equipment trust system in which the communication company 1 does not purchase the equipment for communication which is a trust asset at the time when the trust is finished.

In the present invention, the asset securitizing mechanism as described above is equipped with a mechanism for enabling the principal/interest to be surely paid to the investors and thus reducing the risk. That is, there is prepared a mechanism for supplying the communication company 1 with information representing a means of enabling the investors to secure high profits stably by analyzing the using status of the equipment for communication by the clients. Disclosure of the existence of this mechanism makes the investors feel at ease and as a result it is expected that the securities becomes creditworthy. These securities are easily acceptable in the financial market, and thus issuance of the securities is easily performed. In this sense, this mechanism may be regarded as a mechanism for assisting to surely reserve the refunded underlying assets to be refunded. The assist service of reservation for underlying assets to be refunded can be carried out by an independent business institution. Further, it may be carried out by the communication company 1, the financial institution 5, SPC 6, the rating agency 8 (see FIG. 1) or the like.

Next, the embodiment of the present invention will be described below in more detail.

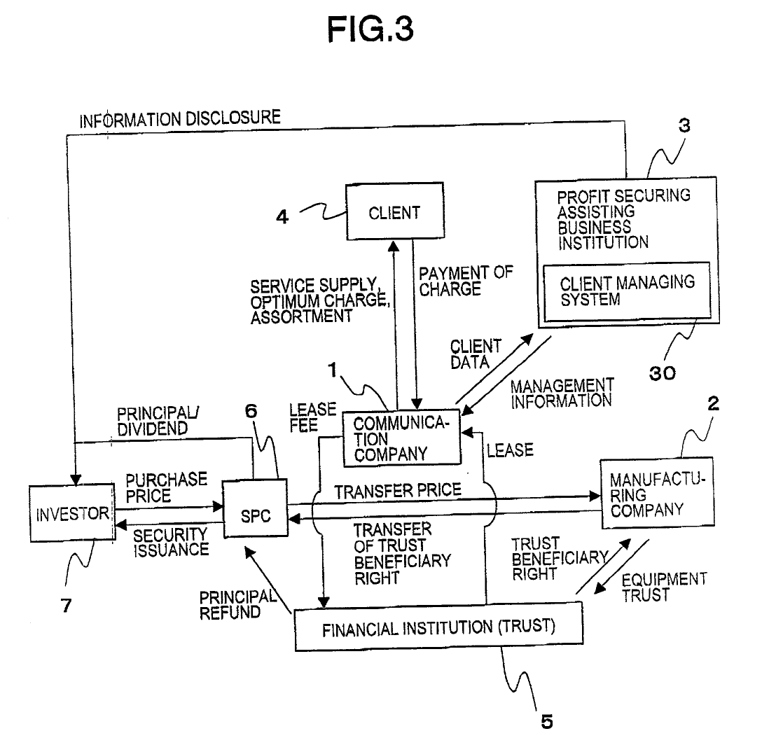

FIG. 3 shows the securitizing mechanism based on the equipment trust system using the mechanism for assisting to secure the refunded underlying assets for refund as described above.

In FIG. 3, there exist the communication company 1 which needs capital investment for the equipment for communication, the manufacturing company 2 which supplies the equipment for communication, the financial institution 5 and the specific purpose company 6 which execute the securitization, the investors 7 and a profit securing assisting business institution 3 which supports the investors to secure the underlying assets for refund. This embodiment has the mechanism used for the equipment trust system that the equipment for communication which is manufactured by the manufacturing company 2 and trust-transferred to the trust business institution such as the financial institution 5 or the like, is leased by the communication company 1.

Further, the trust financial institution 5 issues the trust beneficiary right certificates and grants to the manufacturing company 2. The manufacturing company 2 transfers the trust beneficiary right certificates to SPC 6 to obtain the transfer price and collect the cost of the equipment for communication. SPC 6 issues the securities on the basis of the trust beneficiary right certificates, and sells them to the investors 7 to collect the transfer price. Thereafter, the communication company 1 uses the equipment for communication from the trust financial institution by lease and supplies the equipment for communication to the clients 4 for use thereby to gain the income based on the usage charge. Here, in this embodiment, in response to an instruction from the profit securing assisting business institution 3, a proper charge system is set as a consideration for service supply in order to gain, a profit higher than a certain level of profit. Thereafter, as in the case of FIG. 1 as described above, the payment of the principal and the dividend is carried out.

In the mechanism shown in FIG. 3, the profit securing assisting business institution 3 has a client managing system 30 in order to assist to secure the underlying assets for refund. That is, the client managing system 30 obtains client data from the communication company 1 and analyzes the client data. Thereafter, the client managing system 30 supplies the communication company 1 with the optimum charge system obtained through the analysis result and the information indicating the use status of each client such as assortment information, etc. Further, the client managing system 30 discloses the information indicating the using status of the clients to the purchasers of the securities, that is, the investors 7, whereby the investors can know how the communication company can smoothly secure the profit which is the underlying asset, for refund, of the principal and interest, and the risk of the investment can be reduced.

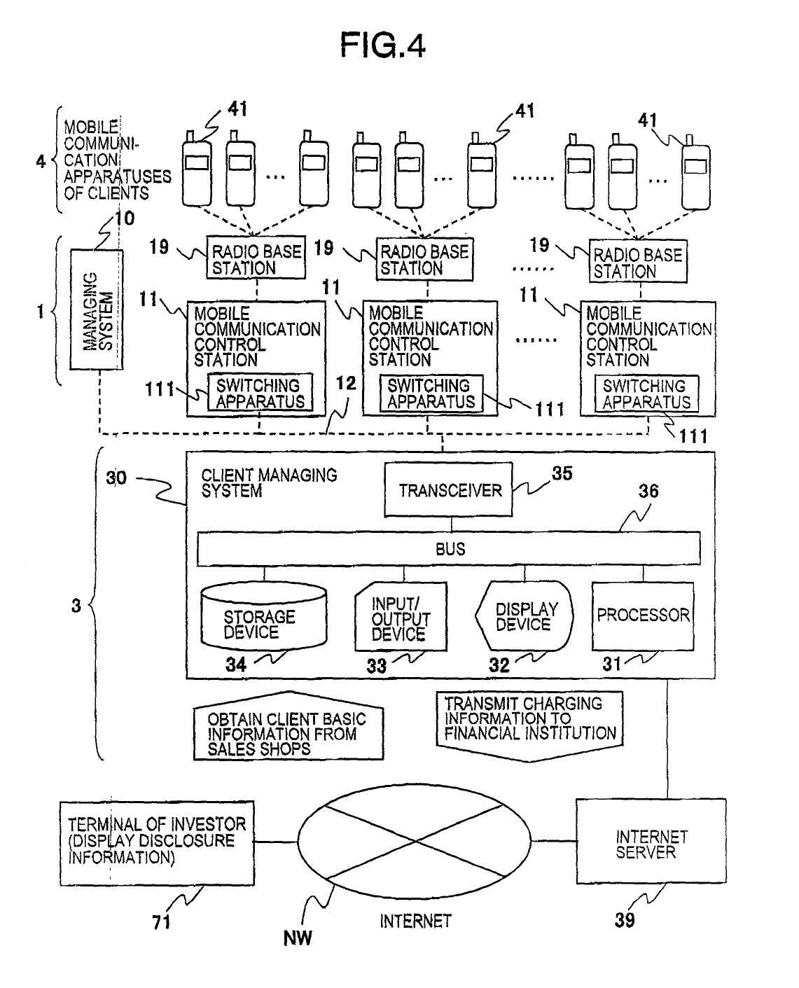

Next, the construction of the client managing system constituting the mechanism for assisting to secure the refunded underlying asset for refund will be described with reference to FIG. 4. FIG. 4 shows a case where communication equipment for supplying communication services with mobile communication apparatus is newly set up to supply such services to clients.

In the case of FIG. 4, it is assumed that a client utilizes the communication services by using a mobile communication apparatus 41. The mobile communication apparatus 41 is wirelessly connected to the nearest radio base station 19 out of the radio base stations placed in respective cells. Each radio base station 19 is connected to the corresponding mobile communication control station 11, and communicated to switching apparatus 111 through a communication line 12, whereby the mobile communication apparatus 41 can communicate with a desired communication target. Further, as shown in FIG. 4, the client managing system 30 is connected to the communication line 12.

The client managing system 30 is constructed by a computer system, and has a processor 31, a display device 32, an input/output device 33, a storage device 34, a transceiver 35 and a bus 36 connecting the above devices to one another. The client managing system 30 is connected to the communication line 12 through the transceiver 35, and thus connected to the mobile communication control stations 11. Further, an internet server 39 is connected to the client managing system 30. The client managing system 30 can supply information to the external, for example, terminals 71 of investors through the internet NW by using the internet server 39.

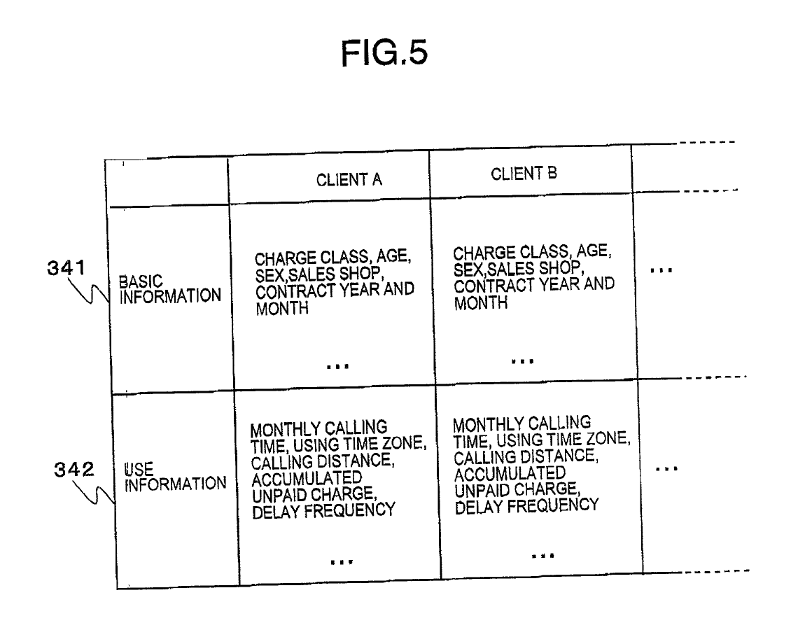

Programs executed by the processor 31 and data, for example, data structured in a data format as shown in FIG. 5 are stored in the storage device 34.

The programs recorded on a recording medium such as an optical disc, a magnetic disc, a magnetooptical disc or the like are read out therefrom by a reading device (not shown) and then stored in the storage device 34. Alternatively, the programs may be received through the communication line 12 and stored in the storage device 34.

Here, the programs contain a program for executing the processing of assisting to secure the profits. It may be considered that the profit securing assist processing program is created by the manufacturing company 2 and supplied to the profit securing assisting business institution 3 or the communication company 1. Alternatively, the profit securing assisting business institution may create the profit securing assist processing program by itself. The communication company 1 publicly announces to secure the profits by using the profit securing assist processing program to show that the risk to the securities is low, thereby effectively promoting the securitization. Accordingly, the supply of the program by the manufacturing company can facilitate the financing of the communication company. As a result, the manufacturing company can promote the sales of equipment. That is, the effect of sales assistance can be expected.

The data contain basic information 341 on respective clients transmitted from distributors (sales shops) and use information 342 transmitted from the mobile communication control station 11. The basic information 341 contains information on a class of the contracted charge, age, distinction of sex, distributor selling the mobile communication apparatus, year, month and day of contract, etc. on a client-by-client basis. The use information 342 contains a monthly calling time, a using time zone, a call distance, an accumulated unpaid charge, frequency of payment delay, etc.

The client 4 can make communications by using the equipment for communication of the communication company 1. That is, the client 4 can communicate with the radio base station 19 by using the mobile communication apparatus 41. The radio base station 19 communicates with the mobile communication control station 11 having a switching apparatus 111. The mobile communication control station 11 communicates with the other mobile communication control stations 11, and also transmit the position of a client 4 (a person who makes a telephone call) and other use information to the client managing system 30. The mobile communication station 11 obtains the information indicating the payment status of each client from the payment managing system (not shown) for managing the payment of each client. On the basis of such data, the information on the consideration payment of each client 4 is analyzed to obtain information to carry out the charge optimization and the assortment of the clients 4. The information indicating what charging system should be established in order to keep profits, that is, how the service charging system should be revised is transmitted as charging information to the financial institution 5 in charge of the client service. Further, in order to disclose the information associated with the safety of the securities to the investors 7 who have purchased the securities, the disclosed information is displayed on the terminal of each investor through the server 39 for the Internet 12.

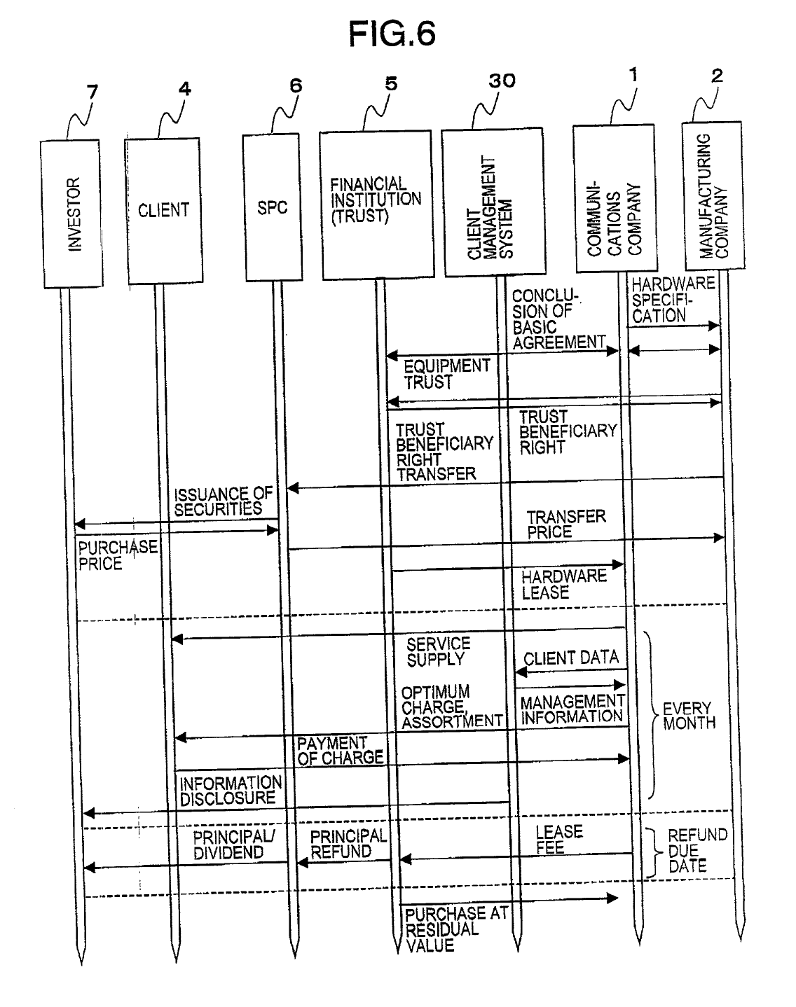

Next, the mutual relationship between the respective subjects in this embodiment will be described with reference to FIGS. 6, 7 and 8.

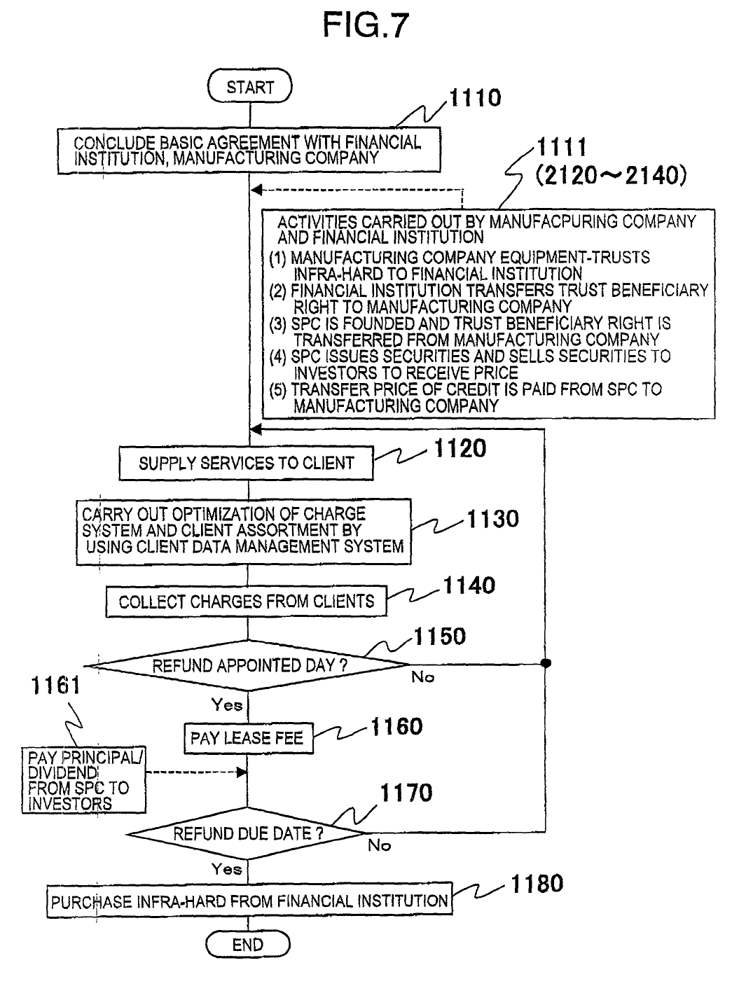

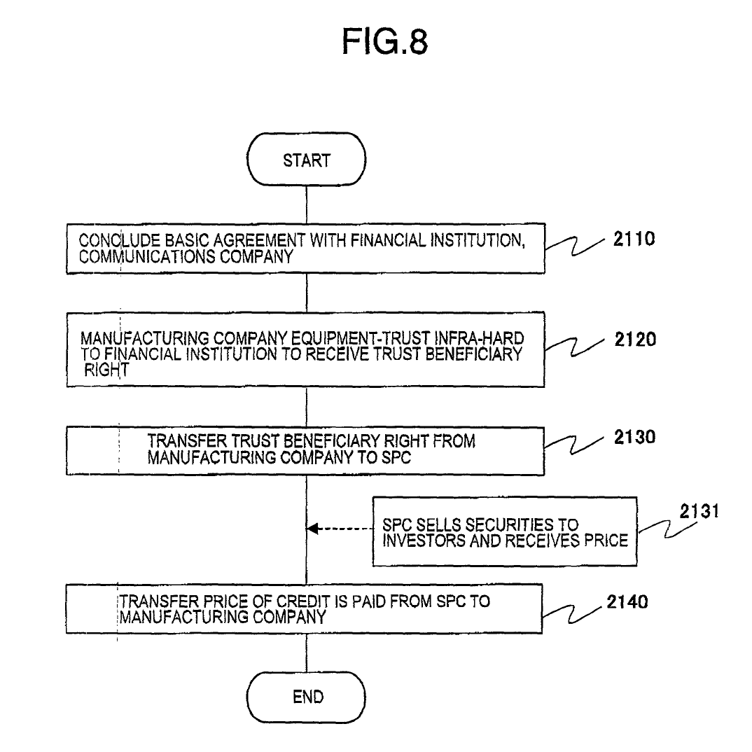

FIG. 6 shows the mutual relationship between the respective subjects on time series. FIG. 7 is a flowchart showing the processing flow with the communication company 1 at the central figure. FIG. 8 is a flowchart showing the processing flow with the manufacturing company 2 as the central figure.

Here, the subjects having the mutual relationship with one another are the manufacturing company 2, the communication company 1, the client managing system 30, the financial institution 5 in charge of the trust business, the specific purpose company SPC (which is set for bankruptcy remoteness of securities), the clients 4 who are telephone users, and the investors 7 who are securities purchasers.

The vertical direction of the drawing of FIG. 6 corresponds to the time flow. The mutual relationship among the respective subjects shown in FIG. 6 is established in two cases where it occurs as a result of an autonomous action of each subject and where it occurs under the control of any one of the subjects. For example, as shown in the flow hart of FIG. 7, the communication company 1 executes the proceedings according to a fixed flow. The whole or a part of the management of the flow of the proceedings may be controlled by the computer of the managing system 10 of the communication company 1.

As shown in the flowchart of FIG. 8, the manufacturing company 2 also executes the proceedings according to a fixed flow. The whole or a part of the management of the flow of the proceedings may be controlled by the computer of the managing system (not shown) of the manufacturing company 2.

As shown in FIG. 6, the specification of the hardware is supplied from the communication company 1 to the manufacturing company 2. Subsequently, the communication company 1, the manufacturing company 2 and the financial institution 5 conclude such a basic agreement that the securitization using the management disposal type equipment trust as a funding method is adopted (step 1110 in FIG. 7, step 2110 in FIG. 8). According to this agreement, the manufacturing company 2 asks the equipment trust of the infra-hard (communication equipment) to the financial institution 5, and receives a trust beneficiary right from the financial institution 5 (step 1111 in FIG. 7, step 2120 in FIG. 8). The manufacturing company transfers the trust beneficiary right to SPC 6 (step 2130 in FIG. 8). SPC 6 issues the securities on the basis of this trust beneficiary right. The investors 7 purchases the securities, and pays the purchase price to SPC 6 (step 2131 in FIG. 8). SPC 6 pays the transfer price of the trust beneficiary right to the manufacturing company 2 on the basis of the purchase price (step 2140 in FIG. 8), whereby the manufacturing company 2 can collectively collect the sales price of the equipment for communication.

After gaining use right of the equipment for communication, the communication company 1 starts to supply services to the clients 4 (step 1120 in FIG. 7). When the services concerned are supplied, the client managing system 3 outputs to the communication company 1 basic information 341 an the charge class, age and sex of each client, a sales shop, contract year and month and the like, and management information 342 on an optimum charge system and client assortment obtained by analyzing a monthly calling time, a using time zone, call distance, an accumulated unpaid charge, frequency of payment delay, etc., and the basic information 341 and the management information 342 are stored in the storage device 34. On the basis of the information described above, the communication company 1 carries out the processing of minimizing the time-variation of the sum of the considerations to be paid by the clients 4 with the optimum charging system and the client assortment by the managing system 10 (step 1130 in FIG. 7), whereby minimized can be the probability that some trouble occurs in payment of the principal/interest of the securities issued. The processing to collect the charge from each client 4, for example, the bill issuing processing, automatic withdrawing processing, etc. (step 1140). These processings can be executed by the managing system 10 of the communication company 1.

Here, the client managing system 30 discloses such information to the Internet server 39 and periodically updates the disclosure. Accordingly, the investors can access the server 39 through the terminals 71 of the investors to browse the information thus disclosed. Therefore, the investors 7 are able to know the safety of the securities. Further, such information may be supplied to the investors by electronic mails.

Subsequently, the communication company monitors redemption date by the managing system 10 (step 1150 in FIG. 7). When the refund due date comes, the processing of paying the lease fee to the financial institution 5 is carried out (step 1160 in FIG. 7). In response to this payment processing, the financial institution 5 pays the principal/dividend to the investors 7 through SPC 6 (step 1161 in FIG. 7). It is checked whether the refund period is finished (step 1170 in FIG. 7). After the refund period is finished, the communication company 1 carries out the processing of purchasing the communication equipment (the hardware constituting the infrastructure) from the financial institution 5 at a residual value (step 1380 in FIG. 7).

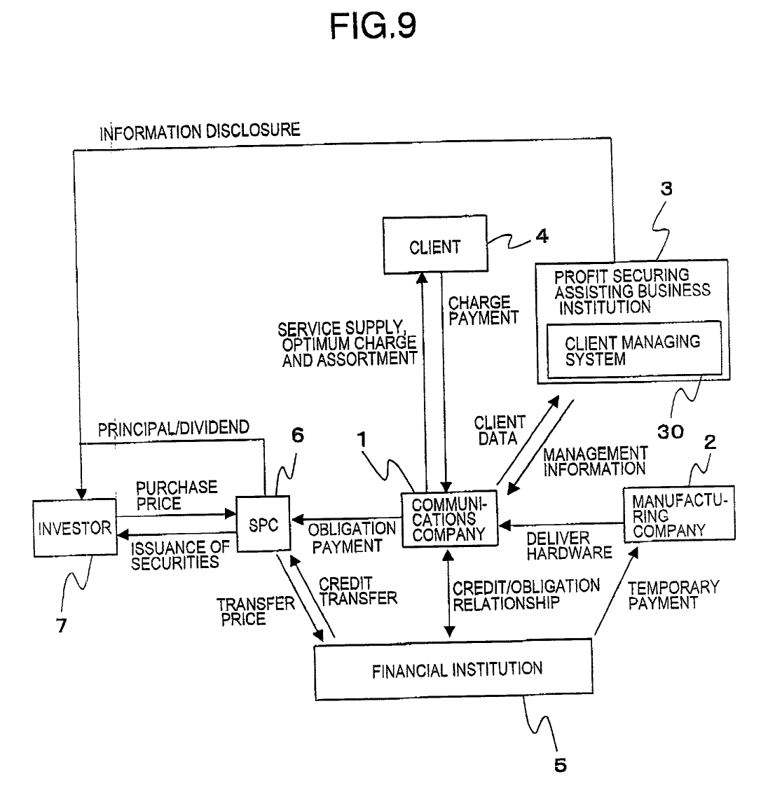

FIG. 9 shows a mechanism of raising funds on the basis of the securitization using the sell-out system. The mechanism shown in FIG. 9 is different from that of FIG. 3 in that the communication company has the ownership of the equipment for communication and a securitization target is the credit to the communication company 1.

In the mechanism shown in FIG. 9 the manufacturing company 2 transfers the equipment for communication manufactured to the communication company 1. Accordingly, the communication equipment is owned by the communication company 1. On the other hand, the manufacturing company 2 receives the manufacturing cost from the financial institution 5. That is, the financial institution 5 pays the manufacturing cost for the communication company 1. As a result, the communication company 1 has an obligation to the financial institution. On the other hand, the financial institution 5 has a credit to the communication company 1. Therefore, the financial institution 5 transfers the credit to SPC 6 and collects the transfer price which has been paid for the communication company. SPC 6 issues the securities for the credit to the communication company 1 which is transferred from the financial institution 5, and sells the securities to the investors 7. The communication company 1 supplies the equipment for communication to the clients 4 for use, and collects the use charge of each client. The income based on the usage charge of the clients 4 is allocated to the payment of the obligation. In this case, the assistance based on the client managing system 30 owned by the profit securing assisting business institution 3 is carried out.

This embodiment has the following advantages: (1) the risk is small for the manufacturing company 2; and (2) the communication company 1 can depreciate the equipment for communication (the communication company 1 owns the communication equipment (hardware)). On the other hand, this embodiment has the following disadvantages: (1) the consumption tax incurs; and (2) the balance sheet of the communication company 1 based on off-balance cannot be lightened (simplified).

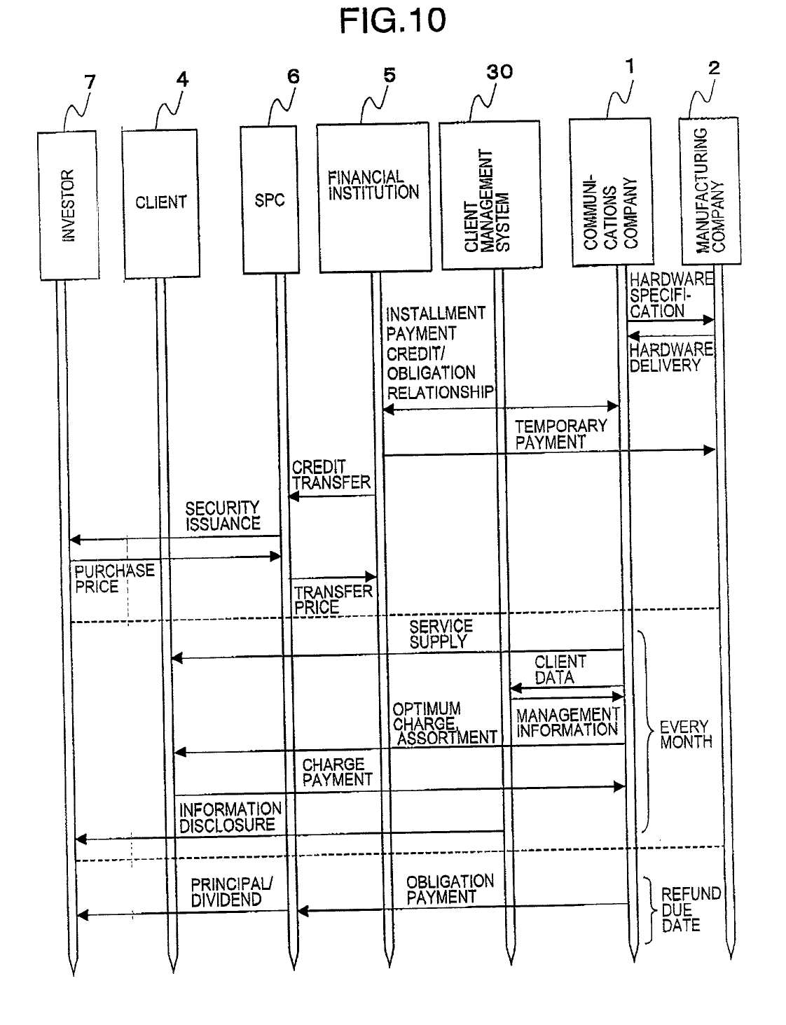

Next, the securitization mechanism of this embodiment will, be described in more detail with reference to FIGS. 10, 11 and 12.

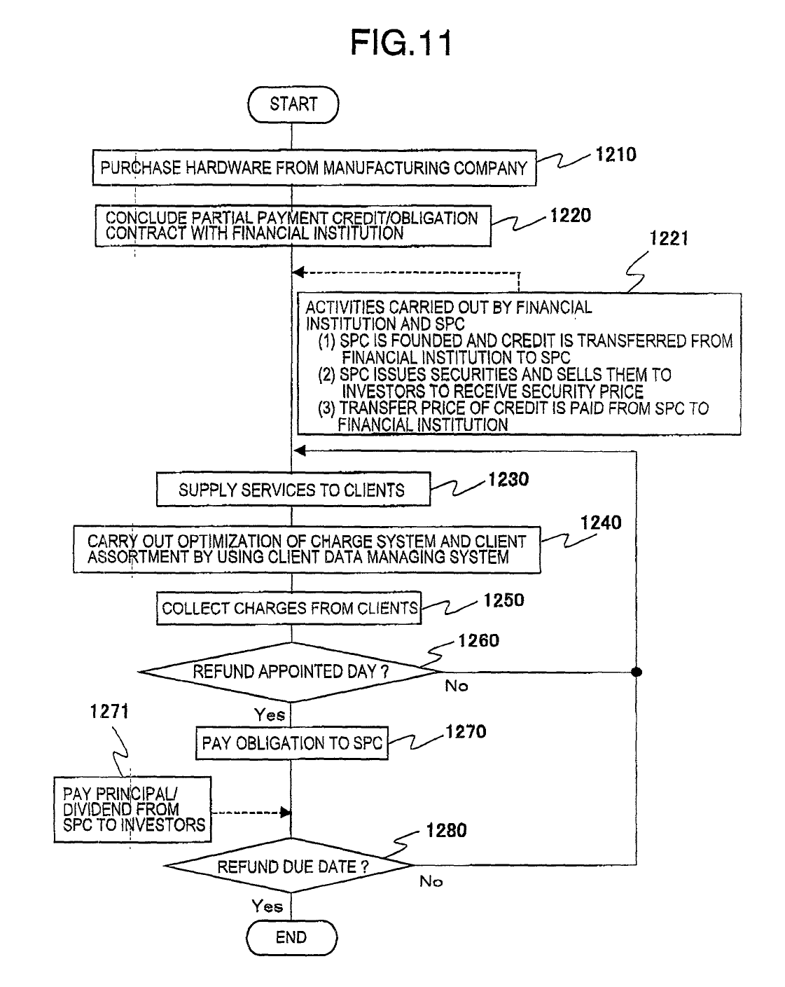

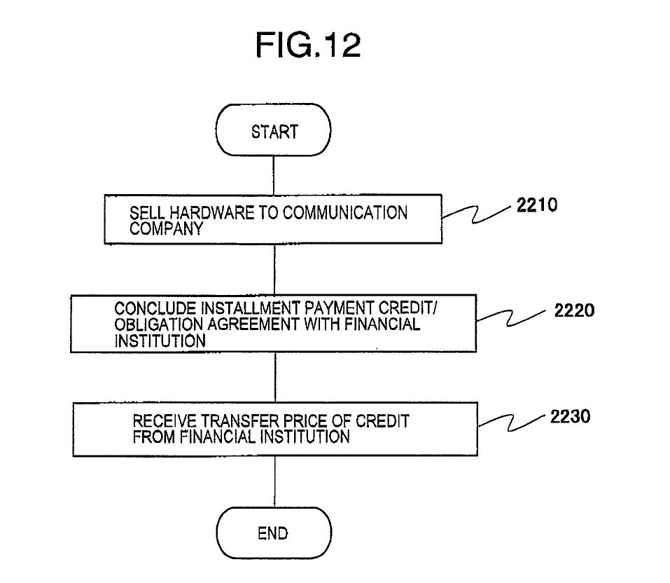

FIG. 10 shows the time series of the mutual relationship among the respective subjects in this embodiment. FIG. 11 is a flowchart showing the proceedings with the communication company at the central figure. FIG. 12 is a flowchart showing the proceedings with the manufacturing company 2 at the central figure. As in the case of FIG. 6, the subjects constituting the system are the manufacturing company 2, the communication company 1, the client managing system 30, the financial institution 5 in charge of the trust business, the specific purpose company SPC 6, the clients 4 who are users of telephones and the investors 7 who are purchasers of securities.

The vertical direction of FIG. 10 corresponds to the time flow. The mutual relationship among the respective subjects shown in FIG. 10 is established in two cases where it occurs as a result of an autonomous action of each subject and where it occurs under the control of any one of the subjects. For example, as shown in the flowchart of FIG. 11, the communication company 1 executes the proceedings according a fixed flow. The whole or a part of the management of the flow of the proceedings may be controlled by the computer of the managing system 10 of the communication company 1. Further, as shown in the flow chart of FIG. 12, the manufacturing company 2 executes the proceedings according to a fixed flow. The whole or a part of the management of the flow of the proceedings may be controlled by the computer of the managing system (not shown) of the manufacturing company 2. The construction of the client managing system 30 is the same as shown in FIG. 4, and thus the duplicative description thereof is omitted.

The communication company 1 supplies the specification of the hardware to the manufacturing company 2. On the basis of this specification, the manufacturing company 2 manufactures the hardware (communication equipment) and carries out the processing of delivering the communication equipment to the communication company 1 (step 2210 in FIG. 12). The communication company 1 carries the processing of purchasing the communication equipment from the manufacturing company 2 (step 1210 in FIG. 11). The manufacturing company 2 executes the processing of concluding an installment payment credit obligation agreement with the financial institution 5 (step 2220 in FIG. 12). The manufacturing company 2 executes the processing of accepting from the financial institution 5 the temporary payment of the cost of the sold communication equipment from the financial institution 5 (step 2230 in FIG. 12).

The communication company 1 executes the processing of purchasing the communication equipment from the manufacturing company 2 (step 1210 in FIG. 11), and executes the processing of concluding the installment payment credit and obligation agreement with the financial institution 5 (step 1220 in FIG. 11). Thereafter, the financial institution 5 and SPC 6 carried out the following processing (step 1221 in FIG. 11). First, SPC 6 is founded and the credit is transferred from the financial institution 5 to SPC 6. SPC 6 issues the securities, and sells them to the investors 7 to receive the price of the securities from the investors 7. Thereafter, the transfer price of the credit is paid from SPC 6 to the financial institution 5, and then the communication company 1 carries out the processing on the proceedings for the telephone services, the charge collection, the payment of the obligation to SPC 6, etc. as in the case shown in FIG. 6 (step 1230 to step 1280 in FIG. 11).

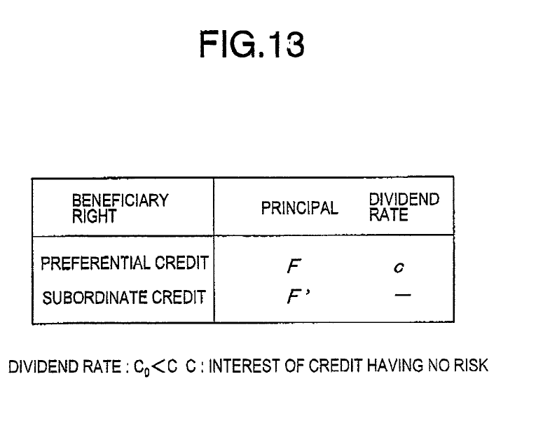

Next, the profit securing assisting service as described above will be described. Here, a security for which the principal/dividend payment must be made as shown in FIG. 13 is picked up as an example.

The preferential credit is assumed to be one kind. A coupon rate c is determined by adding a risk premium to the interest rate of a non-risk credit. The credit enhancement is carried out by the senior/subordinate structures the (underwriting) spread account (Leftover financial resources credit reserving). For securities having more complicated compositions, the same managing method can be applied to. A sales amount is estimated on the basis of an business plan (the number of years, calling time, user characteristic frequency distribution fi^{(k)} (Z), charging system), and discounts the estimated value to the present value by using the term structure of the spot rate, thereby calculating the cash-in-flow Vᵢₙ.

$$\begin{matrix}{V}_{i n} = {\sum }_{k = 1}^{N} \frac{{S}_{k} - {M}_{k}}{{( 1 + {z}_{k} )}^{k}} & ( 1 ) \\ {S}_{k} = {\sum }_{i = 1}^{\text{?}} \int {f}_{i}^{( k )} ( Z ) {p}_{i}^{( k )} ( Z ) [ 1 - {μ}_{i} ( Z ) ] ⅆ Z \\ \text{?} \text{indicates text missing or illegible when filed} & ( 2 )\end{matrix}$$

Here, Sₖ and Mₖ represent the sales amount of a k-th period and the sum of the labor costs and the maintenance cost of the k-th period, respectively. The user characteristic variation Z represents the calling time, the calling time zone, the call distance, etc., and it is extracted by data mining or analysis of main components. Further, the term structure of the spot rate Zₖ is determined from the yield curve of a national bond by Bootstrap methods. Further, the charge uncollected rate μᵢ(Z) of a charge class i is determined from past data in consideration of enhancement of the collected rate which is expected by the client management. fᵢ^{(k)}(Z), pᵢ^{(k)}(Z) represents the user characteristic frequency distribution of the charge class i and the k-th period and the charge system of the charge class i and the k-th period. Examples of the charge class includes a class in which a comparatively low charge is set to a long-distance telephone call, a class in which a comparatively low charge is set to a call for an Internet connection, a class in which a low telephone charge is set to a telephone call during the night, a class in which a comparatively low telephone charge is set to a telephone call with previously registered receiver. In addition to these classes, various classes may be set in accordance with the heeds of the clients 4. The cash-in-flow Vᵢₙ is equal to the sum of the credit enhancement price and the present value of the total of the principal refund of the securities, the payment of the dividend and the fees and thus the following equation is obtained.

$${V}_{i n} = {V}_{out} + {\sum }_{k = 1}^{N} \frac{{α}_{k}}{{( 1 + {z}_{k} )}^{k}} + {F}^{′} \qquad ( 3 )$$

Here, a^{k} represents the fee of the k-th period. The present value Vₒᵤₜ of the issued securities can be calculated by discounting the cash-flow of the payment of the principal refund of the securities and the dividend to the present value by using the term structure of the spot rate.

$${V}_{\text{?}} = {\sum }_{i = 1}^{n} \frac{Fc}{{( 1 + {z}_{i} )}^{i}} + \frac{F}{{( 1 + {z}_{n} )}^{n}} \\ \text{?} \text{indicates text missing or illegible when filed} \qquad ( 4 )$$

The credit enhance price (subordinate price) F′ is calculated from a loss cost distribution determined by using an actuarial model in accordance with the target rating of the issued securities. Representing the face value by B, the number of issued securities is equal to F/B. It is apparent from the equations (1) and (2) that the variation of the cash-in-flow Vᵢₙ is induced by the variation of the charge uncollected rate μᵢ(Z), and it is apparent from the equations (3) and (4) that the cash-in-flow Vᵢₙ must be stable in order to carry out the principal refund of the securities and the payment of the dividend as scheduled.

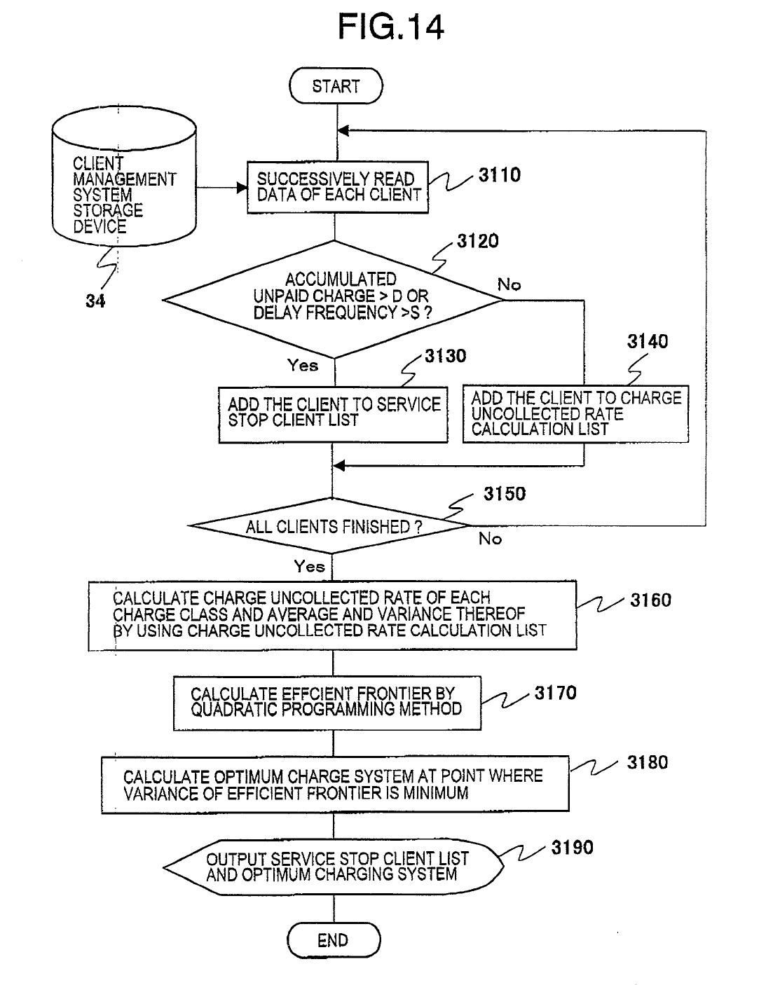

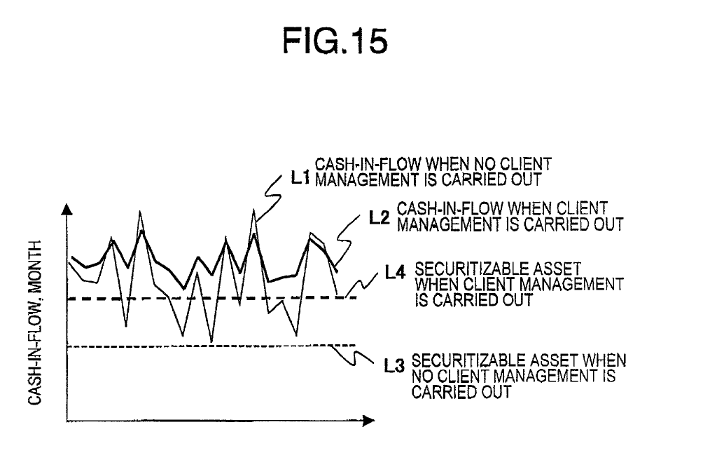

Therefore, the processor 31 of the client managing system 30 carries out the client management according to the flow shown in FIG. 14 and applies the optimum charging system as occasion demands to thereby stabilize the cash-in-flow Vᵢₙ. If the cash-in-flow Vᵢₙ is stabilized by the client management, the securitizable assets are increased as shown in FIG. 15, and the funding (raising funds) on the basis of the safe and effective securitization can be performed.

In FIG. 15 shown are a line graph L1 representing the variation of the cash-in flow when no client management is carried out, a line graph L2 representing the variation of the cash-in-flow when the client management is carried out, a broken line L3 representing the securitizable assets when no client management is carried out, and a broken line L4 representing the securitizable assets when the client management is carried out. As is apparent from FIG. 15, the cash-in-flow L1 when no client management is carried oat is greatly varied. There frequently occurs a case where the cash-in-low is decreased to a very low value. Therefore, there exists a month in which the cash for payback cannot be secured. Accordingly, there is a probability that the refund to the investors is left unpaid in some months. Therefore, in the case of the securitizable assets when no client management is carried out, a value lower than the lowest value of L1 is set to the upper limit value of the securitizable assets, as shown by L3. On the other hand, in the case of the cash-in-flow when the client management is carried out, the monthly variation is small. Particularly, the cash-in-flow is hardly decreased. Therefore, as shown by the line L4, the securitizable assets when the client management is carried out can be set to a further larger price than that shown by L3. Accordingly, when the client management is carried out, the securitization can be performed under a favorable condition, that is, at a low interest rate because the risk is low. Further, the amount of funds which can be raised is greater because the securitizable assets are large.

According to the flowchart of FIG. 14, the processor 31 reads the client data from the storage device 34 of the client managing system 30 (step 3110) to check whether there are clients 4 who have a predetermined or more amount of accumulated unpaid charge or a predetermined or more delay frequency (step 3120). If there exists any client who is fit into the condition that his/her accumulated unpaid charge is larger than a predetermined value or his/her delay frequency is larger than a predetermined value S, the client 4 concerned is added to a service stop list (step 3130). On the other hand, the other clients are added to a charge uncollected rate calculating list (step 3140). This processing is carried out on all the clients (step 3150).

Subsequently, the processor 31 calculates the charge uncollected rate of each charge class and the average and covariance thereof are calculated by using the charge collecting rate calculation list (step 3160). Thereafter, the efficient frontier is calculated by using the quadratic programming method (step 3170). Further, the optimum charging system is calculated at a point when the variance of the efficient frontier is minimum (step 3180). The service stop client list and the optimum charging system which have been obtained in the above processing are outputted (step 3190).

Upon receiving the above output, the management system 10 of the communication company 1 carries out the processing of stopping the services to the clients 4 which are registered in the service stop client list, whereby the user characteristic frequency distribution fᵢ^{(k)}(Z) is adjusted to increase the cash flow.

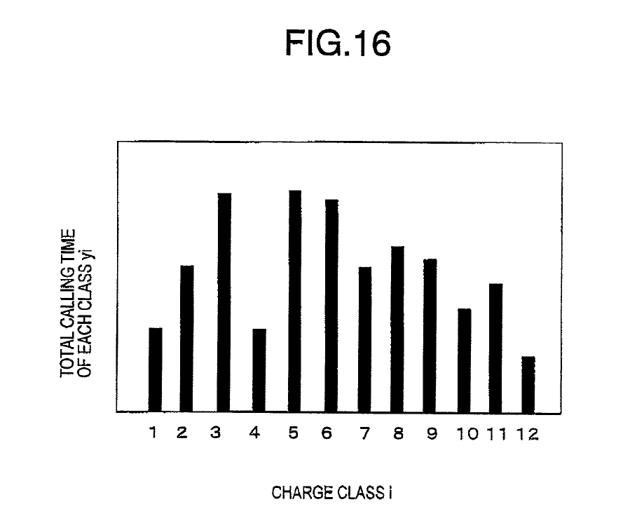

Next, each calculation in the steps 3160 to 3180 will be described in more detail. First, as shown in FIG. 16 the clients 4 to which the services are continuously supplied are classified in accordance the charge class, and the total calling time yᵢ of each class is calculated, thereby creating a client portfolio. Further, the charge uncollected rate μᵢ(Z) of the charge class i is calculated by using the user characteristic variable Z. It is desirable that the expected value Ex[R(x)] of the collected rate of the overall portfolio R(x)=ΣR₁χ₁ is large, and the variance of the collected rate Vr[R(x)] is small. Accordingly, the optimum charging system can be determined by solving the following optimization problem.

$$\begin{matrix}Minimizing : Vr [ R ( x ) ] = {\sum }_{i} {\sum }_{j} Ex [ ( {R}_{i} - {r}_{i} ) ( {R}_{j} - {r}_{j} ) ] {x}_{i} {x}_{j} & ( 5 ) \\ = {\sum }_{i} {\sum }_{j} {σ}_{ij} {x}_{i} {x}_{j} & \\ Condition : Ex [ R ( x ) ] = {\sum }_{i} Ex [ {R}_{i} ] {x}_{i} = {\sum }_{i} {r}_{i} {x}_{i} \text{?} ρ & \\ {\sum }_{j} {x}_{j} = 1 , {x}_{j} \geq 0 & ( 6 ) \\ \text{?} \text{indicates text missing or illegible when filed} & \end{matrix}$$

Rᵢ=1−μᵢ represents the collected rate of the charge class i. By using the total calling time yᵢ of the charge class i, xᵢ is defined as

$${ρ}_{i} {y}_{i} / {\sum }_{k} {ρ}_{k} {y}_{k}$$

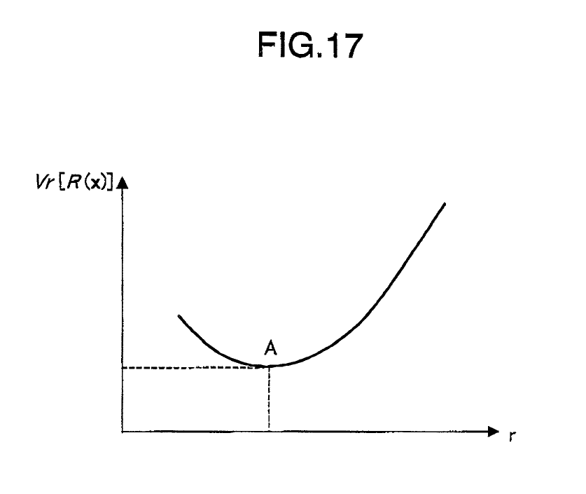

The efficient frontier as shown in FIG. 17 is obtained by calculating the expected value rᵢ of the collected rate of the charge class i, the covariance σᵢⱼ between the charge class i and the collected rate of the charge class j and solving the equations (5) and (6), by the use of the quadratic programming method. The optimum charging system Pi is calculated from xᵢ corresponding to a point A at which the variance is minimum on the efficient frontier.

The service stop client list and the optimum charging system obtained in the above processing are outputted to the communication company. The communication company 1 assorts undesired clients and applies the optimum charge on the basis of the above information, whereby the cash-in-flow is stabilized. With respect to the assortment of the clients, the effect can be further enhanced by carrying out a payment promotion campaign to charge unpaid clients and enhancement in efficiency of giving incentives to sales shops to prevent the securities from being kept unused (idle prevention).

Finally, a method of disclosing the information to the investors 7 will be described.

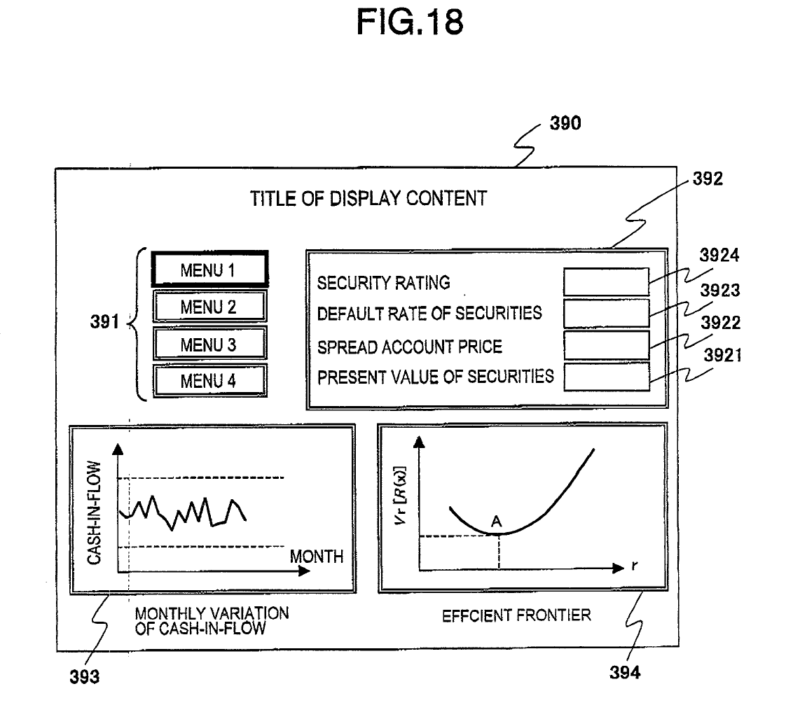

An information disclosing web site as shown in FIG. 18; is opened in the internet server 39. Through this web site, the information on safety of securities is disclosed to the investors 7 who have purchased the securities. This home page is renewed periodically, so that the investors 7 can grasp the value of the securities concerned on a real-time basis. As the disclosed information provided are information 392 on a securitization product which contains the present value 3921 of the securitization product, a rating 3924, a default rate 3923 and a spread account price 3922, a graph 393 showing the monthly variation of the cash-in-flow (see FIG. 15), a graph 394 showing the efficient frontier representing the optimization of the charge (see FIG. 17), etc.

The present value 3921 of the securitization product and the monthly variation 393 of the cash flow in the above information will be specifically described.

Next, a method of determining the present value of the securitization product will be described.

As a method thereof, known are a method of discounting to the present value by using the term structure of the interest rate and a method of obtaining the present value based on a partial differential equation or Monte Carlo Simulation using interest rate probability model. Since the credit enhancement is carried out as shown in the equation (3), the effect of the non-payment of the telephone charge oil the preferential credit price can be neglected. According to the former method, the price P of the security of the face value is equal to the present value of the cash-out-flow and thus it can be calculated as follows:

$$P = {\sum }_{j = 1}^{n} \frac{{c}_{j} B}{{( 1 + {z}_{j} )}^{j}} + \frac{B}{{( 1 + {z}_{n} )}^{n}} \qquad ( 7 )$$

According to the latter method, a bond having _{c}B of a coupon payment in each period at expiration T=tₙ and face value B is the same value as the portfolio of a discount bond, and thus it can be calculated by determining the price P_{d}(τ) of the discount bond at the time t.

$$P = {\sum }_{i = 1}^{n} {cBP}_{d} ( {t}_{i} ) + {BP}_{d} ( T ) \qquad ( 8 )$$

As a probability mode of the interest rate, the price P_{d}(τ) of the discount bond when a single factor balanced model of Cox-Ingersoll-Ross is used, can be obtained by solving the following partial differential equation.

$$\frac{\partial {P}_{d}}{\partial t} + a ( \overline{r} - r ) \frac{\partial {P}_{d}}{\partial r} + \frac{{σ}^{2} r}{2} \frac{{\partial }^{2} {P}_{d}}{\partial {r}^{2}} = r {P}_{d} \qquad ( 9 )$$

The present value of the security can be known on a real-time basis according to the above two methods. As a result, when an investor 7 buys/sells the security concerned before the maturity, the security concerned can be bought/sold at a proper price.

Next, the monthly variation of the cash flow will be described.

When a securitization product is constructed, stress is applied to risk factors such as the interest, the user characteristic frequency distribution, the charge unpaid rate, etc. The cash flow of the securitization product and the risk sensitivity are analyzed with the Monte Carlo simulation by using the risk factors to which the stress is applied. The securitization product is constructed so that no problem arises in payment of the principal/interest of the security within the range of the expected cash flow. The cash-in-flow Vᵢₙ, the estimated value V_{d} of the actual cash flow, etc. are provided as the quantities associated with the cash flow to be displayed.

$${V}_{d} = \int ( {V}_{i n} - {V}_{out} ) ⅆ t - {\sum }_{k = 1}^{n} \frac{{α}_{k}}{{( 1 + {z}_{k} )}^{k}} - {F}^{′} \qquad ( 10 )$$

The range of the cash flow which is expected from a stress test in displayed on the disclosed information frame, and the monthly variation of the actual cash flow is superposed on the expected range of the cash flow, whereby the investors 7 can grasp the safety degree of the securitization products on a real-time basis.

As described above, the probability that a trouble occurs in payment of the principal/interest of the issued securities can be minimized by performing the client management to assist the securing of profits. The financial transaction method which has the above function and can securitize assets can be implemented, and the system therefor can be constructed.

Further, by performing the client management to assist the securing of the profits, the charge can be optimized and the clients can be assorted on the basis of the information obtained by analyzing the information on the payment of the consideration of each client. That is, the time-variation of the total considerations to be paid by the clients is minimized by using the system for performing the client management processing, thereby minimizing the probability that a trouble occurs in the payment of the principal/interest of the securities issued.

As described above, according to the present invention, it can be assisted to secure the profits which are gained by use of the enterprise equipment. Therefore, the securitization of the introduction of the equipment concerned can be advantageously performed by supplying the client management system or the program therefor to the enterprise company which wishes to introduce the enterprise equipment.

Accordingly, the financing of the enterprise company concerned can be facilitated. This means that the equipment manufacturing company can more easily sell the equipment from a financing standpoint as compared with other companies.

In the financial market, investors can feel at ease for their investment, as long as information on the security is disclosed, indicating an assured refund. Accordingly, according to the securitization of the present invention, safe financial products can be provided to the investors by securitization for raising funds to introduce enterprise equipment.

While we have shown and described embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

What is claimed is:

1. A method of securitizing an asset to raise a fund needed to introduce equipment for communications or enterprise with which is the asset to gain profit based on a consideration paid by a client, wherein
it is conditioned that it is assisted to secure profit from the equipment introduced when securitization is carried out;
the assistance is carried out during a security refund period by a computer system connected to a system which operates the equipment;
and said computer system
obtains from said system operating the equipment information on payment of the consideration paid by client which occurs due to use of the equipment and stores the information,
investigates a payment status of each client on a basis of the stored information on the payment of th consideration,
performs charge optimization processing to suppress reduction of the amount of money paid by the client based on the payment status, and outputs information representing a charging system.

2. The method according to claim 1, wherein said computer system further carries out client assortment processing which contains the processing of stopping services to the client whose payment status is bad.

3. The method according to claim 1, wherein said computer system minimizes the time-variation of the sum of the consideration paid by the client when the charge optimization processing is carried out, thereby achieving a charging system which can secure profit to enable the refund of the securities.

4. The method as according to claim 1, wherein said computer system further generates disclosure information on investors, the disclosure information comprising a graph representing the time-series variation of a cash-in-flow.

5. The method according to claim 1, wherein the securitization is carried out as follows; a manufacturing company having the asset transfers an underlying asset to a trust bank to create a trust beneficiary right which has been subjected to a senior/subordinate structure; a specific purpose company sells securities for the trust beneficiary right to a investor; and an enterprise company supplies a service to the client by using the asset leased from the manufacturing company to refund on a basis of the consideration to the service which is paid by the client.

6. The method according to claim 1, wherein the securitization is carried out as follows: a manufacturing company having the asset transfers an underlying asset to a trust bank and sells securities being a certificate of trust beneficiary right, to a investor; and an enterprise company supplies a service to the client by using the asset leased from the manufacturing company to refund on the basis of the consideration to the service which are paid by the client.

7. The method according to claim 1, wherein the securitization is carried out as follows: a financial institution having a credit/obligation relationship with an enterprise company transfers a credit to a specific purpose company; the specific purpose company sells to a investor securities which have been subjected to a senior/subordinate structure; and the enterprise company supplies a service to the client by using its owned asset to refund on a basis of the consideration to the service which is paid by the client.

8. An asset securitizing system for securitizing an asset to raise a fund needed to introduce equipment for communication or enterprise to gain profit based on a consideration paid by a client, comprising a computer system for assisting to secure profit from the equipment introduced when the securitization is carried out, wherein
said assisting computer system comprises:
means for transmitting/receiving data to/from a system which operates the equipment;
means for obtaining information on payment of the consideration paid by each client which occurs due to use of the equipment from the system operating the equipment and storing the information,
means for investigating a payment status of each client on the basis of the stored information on the payment of the consideration; and
means for performing charge optimization processing to suppress reduction of the amount of money paid by the client based on the payment statues to output information representing a charge system.

9. The system according to claim 8, wherein said assisting computer system further comprises means for carrying out client assortment processing which contains the processing of service stopping to the client whose payment status is bad.

10. The system according to claim 8, wherein said means for performing charge optimization minimizes the time-variation of the sum of the consideration paid by the client when the charge optimization processing is carried out, thereby achieving a charging system which can secure profit to enable a refund of the securities.

11. The system according to claim 8, wherein said computer system further comprises means for generating and updating disclosure information.

12. The system according to claim 11, wherein said computer system is connected to a server to transmit the disclosure information to said server to be capable of viewing the disclosure information for a investor.

13. The system according to claim 11, wherein the disclosure information comprises a graph representing the time-series variation of a cash-in-flow.

14. A system for assisting to secure profit from an asset when the asset is securitized to raise a fund needed to introduce equipment for enterprise or communication to gain profit based on a consideration paid by a client, comprising a computer system for assisting to secure profit from the equipment introduced when the securitization is carried out, wherein:
said assisting computer system includes;
means for transmitting/receiving data to/from a system which operates the equipment;
means for obtaining information on payment of the consideration paid by each client which occurs due to use of the equipment from the system operating the equipment and storing the information;
means for investigating a payment status of each client on the basis of the stored information on the payment of the consideration; and
means for performing charge optimization processing to suppress reduction of the amount of money paid by the client based on the payment status to output information representing a charge system.

15. The system according to claim 14, wherein said computer system is connected to a server to transmit the disclosure information to said server to be capable of viewing the disclosure information for a investor.

16. The system according to claim 14, wherein the disclosure information comprises a graph representing the time-series variation of a cash-in-flow.

17. A method of assisting to introduce equipment to gain profit based on a consideration paid by a client, comprising the steps of:
issuing securities, which is to be refunded with profit based on a consideration in order to raise a fund needed to introduce equipment for enterprise or communication;
constructing a computer system for assisting to secure profit from the equipment introduced when the securities are issued; and
connecting the assisting computer system to a system operating the equipment and continuously carrying out, during at least a security refund period, (1) the processing of obtaining from a system operating the equipment information on payment of the consideration paid by each client which occurs due to use of the equipment and storing the information, (2) the processing of investigating a payment status of each client on a basis of the stored information on the payment of the consideration, (3) the processing of performing charge optimization processing to suppress reduction of the amount of money paid by the client based on the payment status and (4) the processing of outputting information representing a charge system.

18. A computer-readable storage medium for holding a computer program to implement:
a step of obtaining, from a system operating equipment for enterprise or communication, information on payment of the consideration paid by each client which occurs due to use of the equipment and storing the information;
a step of investigating a payment status of each client on a basis of the stored information on the payment of the consideration; and
a step of performing charge optimization processing to suppress reduction of the amount of money paid by the client based on the payment status and outputting information representing a charge system.

19. A computer program product comprising:
computer readable program code means for obtaining, from a system operating equipment for enterprise or communication, information on payment of the consideration paid by each client which occurs due to use of the equipment and storing the information;
computer readable program code means for investigating a payment status of each client on a basis of the stored information on the payment of the consideration; and
computer readable program code means for performing charge optimization processing to suppress reduction of the amount of money paid by the client based on the payment status and outputting information representing a charging system.
